(19) United States
(12) Patent Application Publication
(10) Pub. No.: US 2008/0280249 A1
(43) Pub. Date: Nov. 13, 2008

(54) Dental Impression Bite Tray

(76) Inventor: Suk Choi, Gyunggi-Do (KR)

Correspondence Address: SCHMEISER OLSEN & WATTS, 18 E UNIVERSITY DRIVE, SUITE # 101, MESA, AZ, 85201, US

(21) Appl. No.: 11/914,410

(22) PCT Filed: Jan. 5, 2007
(86) PCT No.: PCT/KR2007/000116

§ 371 Date: Nov. 14, 2007

(30) Foreign Application Priority Data
Jan. 9, 2006 (KR) 10-2006-0002196

(51) Int. Cl. A61C 9/00

(52) U.S. Cl. 433/38

(57) ABSTRACT

The present invention is referred to the disposable bite trays among the dental impression trays. The metallic reinforcements of the invented tray are fixed by exposing to the exterior of the connecting loops on the both sides of the impression obtaining walls. The reinforcements should include an impression obtaining membrane in the central portion, the moving freely prevention stair, and various moving freely prevention grooves. The moving freely prevention stair is to fix the plastic supporter and reinforcement together and prevent the individual movement of the supporter and reinforcement. The disposable bite trays are usually made up of plastics because they are easy-to-make materials, cheap, and convenient to use. However, no matter how strong plastics those are used, the connecting loops of the impression obtaining walls on the both sides of the tray will still be thin and narrow. It is because the connecting loops go into the inner space where maxillary and mandibular molars occlude, and so they have to be thin and narrow. In this case, the connecting loops of the impression obtaining walls can become weak and may result in twist or warp of the impression materials when obtaining the dental impression. These deformed impression materials may make difficult to obtain an elaborate teeth impression. Therefore, in the present invention, the metallic reinforcement was added to the connecting loop of the plastic tray. This will make the plastic tray rigid as a metal tray and make adjustable. For instance, dentists may be able to adjust the width of the tray or cross the impression obtaining walls. This customized tray will provide a safe disposable bite tray to obtain an elaborate teeth impression.

### TECHNICAL FIELD

The present invention is referred to the disposable bite trays among the dental impression trays, a metallic reinforcement is added to the connecting loop on the both sides of the impression walls of the plastic tray. The reinforcement, produced thinly and narrowly, was exposed to the exterior, and, the both ends of the reinforcements were fixed by inserting to the impression walls. The reinforcement was also inserted to the inside of the central portion on the impression membrane and fixed with the plastic supporter. This structure would keep the merits of the conventional-plastic disposable bite tray, which is that the impression membrane inside of the connecting loop does not move up and down, and, the moving freely prevention stair and the moving freely prevention grooves help obtaining the impression finely and elaborately.

The use of these reinforcements make the connecting loop, which is the weakest part of the tray, strong and rigid, even if the disposable bite tray is made up of plastics. In addition, the present invention complements the weakness of the conventional-plastic disposable bite tray. The width of the invented tray is adjustable as a metallic tray, the impression walls can be crossed, and the strength and rigidness of the invention prevent the deformation of the impression materials.

### BACKGROUND ART

In order to prepare a dental prosthetic appliance, generally, a patient's intra-oral dental-impression needs to be obtain. The instrument using in this process is called a dental impression tray, also called a bite tray in a technical term. The bite tray consists of a hollow structure to retain impression materials, which is to obtain an intra-oral impression for patient's dental prosthesis, and a handle fixed to the hollow structure. The structure of this bite tray is useful for the method of extrusion, blow molding, injection molding, compression molding and vacuum molding. Most dentists in Korea and other advanced countries use disposable bite trays because of their hygiene and convenience. The disposable trays made up of cheap and easy-to-make materials, such as fibers, films, PP (polypropylene), and ABS resin, and etc.

However, the plastic-made disposable bite trays result in the following problems.

No matter how strong plastics those are used, the connecting loops of the impression obtaining walls on the both sides of the tray will still be thin and narrow. It is because the connecting loops go into the inner space where maxillary and mandibular molars occlude, and so they have to be thin and narrow. In this case, the connecting loops of the impression obtaining walls can become weak and may result in twist or warp of the impression materials when obtaining the dental impression. These deformed impression materials may make difficult to obtain an elaborate teeth impression.

Therefore, in the present invention, the metallic reinforcement was added to the connecting loop of the plastic tray. This will make the plastic tray rigid as a metal tray and make adjustable. For instance, dentists may be able to adjust the width of the tray or cross the impression obtaining walls. This customized tray will provide a safe disposable bite tray to obtain an elaborate teeth impression.

### DISCLOSURE OF INVENTION

In the present invention, a metallic reinforcement is added to the connecting loop on the both sides of the impression walls of the plastic tray. The reinforcement, produced thinly and narrowly, was exposed to the exterior, and, the both ends of the reinforcements were fixed by inserting to the impression walls. The reinforcement was also inserted to the inside of the central portion on the impression membrane and fixed with the plastic supporter. This structure would keep the merits of the conventional-plastic disposable bite tray, which is that the impression membrane inside of the connecting loop does not move up and down, and, the moving freely prevention stair and the moving freely prevention grooves help obtaining the impression finely and elaborately.

The disposable bite trays are usually made up of plastics because they are easy-to-make materials, cheap, and convenient to use. However, no matter how strong plastics those are used, the connecting loops of the impression obtaining walls on the both sides of the tray will still be thin and narrow.

It is because the connecting loops go into the inner space where maxillary and mandibular molars occlude, and so they have to be thin and narrow. In this case, the connecting loops of the impression obtaining walls can become weak and may result in twist or warp of the impression materials when obtaining the dental impression. These deformed impression materials may make difficult to obtain an elaborate teeth impression.

Therefore, in the present invention, the metallic reinforcement was added to the connecting loop of the plastic tray. This will make the plastic tray rigid as a metal tray and make adjustable. For instance, dentists may be able to adjust the width of the tray or cross the impression obtaining walls. This customized tray will provide a safe disposable bite tray to obtain an elaborate teeth impression.

### BRIEF DESCRIPTION OF DRAWINGS

The following figure-descriptions are regarded to the present invention.

FIG. 1 is a side view of the dental impression bite tray.

FIG. 2 is a plan view or the dental impression bite tray.

FIG. 3 is a side view of the reinforcement, which is fixed in the central portion both sides of the impression obtaining walls.

FIG. 4 is a cross-section view of A-A line shown in FIG. 3.

FIG. 5 is another side view of the reinforcement,

### DESCRIPTION FOR THE MAIN PARTS OF THE DRAWINGS

100: Dental Impression Bite Tray,
110: Handle,
120: Impression obtaining wall,
122: Metallic reinforcement,
124: Moving freely prevention projection for impression materials,
130: Impression obtaining membrane,
140 Central portion,
150: Moving freely prevention stair,
150a: Moving freely prevention grooves
160: Reinforcement-membrane supporting plastic area.
170: Supporter to strengthen the handle.

### BEST MODE FOR CARRYING OUT THE INVENTION

To solve the prenominate problems, the structure of the present invention characterizes with the following components: a handle and its supporter; an impression wall supporting impression materials; an impression membrane in the central portion of the impression wall, providing a hollow space to retain impression materials for obtaining the impression; retentive components, reinforcement, fixed by either inserting to the inner surface or exposing to the outer surface; and a moving freely prevention stair with a rough surface to link the impression membrane to the reinforcement.

For the impression membrane, it is better to use a nonwoven fabric or mesh than a woven fabric because a nonwoven fabric or mesh has tight, irregular and airy fibrous tissue. Due to this fiber structure, the nonwoven fabric or mesh shows a strong penetration and sticking when it connects to the impression materials, so that the impression materials can easily separate from the impression wall.

Silicons and alginates are two common resources using for the dental impression materials. When using alginates, it can be very watery. The impression membrane needs to be hard enough to support the impression materials, otherwise, the membrane can be torn. When using silicons, the occluding force and saliva can make the partition weak. For these reasons, the nonwoven fabric needs a proper thickness, range of 0.003˜0.006 inch.

In the case of using plastic impression walls for this invented tray, the following harmless materials are recommended for the reinforcement in the central portion. The recommending materials are brasses, aluminiums, stainless steels, brass alloys, zinc alloys, general metals, and die casting moldings. These materials will help maintaining the original wall of the teeth impression acquisition disposable bite tray and preventing it from distorting. When the reinforcement in the central portion of the outer surface are exposed to the exterior, the rough surface for the moving freely prevention stair and various moving freely prevention grooves are necessary to unify the impression membrane and the reinforcement. In this way, the invention will provide a safe and useful dental impression tray.

The moving freely prevention projection for impression materials should be formed in a jagged shape on the inner surface of the prenominate impression wall. The jagged shape will prevent the moving freely of the impression materials when obtaining the dental impression.

The moving freely prevention projection for impression materials in a jagged shape may be produced in two ways. One is that both sides are slant to the interior with a certain angle in a diamond shape. Another is that which both sides are slant from the exterior to the interior in an inverse-diamond shape, wave shape, jagged shape, or a perpendicular shape.

The moving freely prevention projection for the prenominate impression materials may also be formed to preserve the established angle with keeping the jagged or the semicircular shape.

For the impression mold, various grooves may be formed on the inner surface of the wall to prevent the moving freely of the impression materials.

The grooves are to carry the impression materials and may be formed horizontally to the moving freely prevention projection with a certain depth or with apertures.

The invention will be more specifically explained by reference to the following drawings.

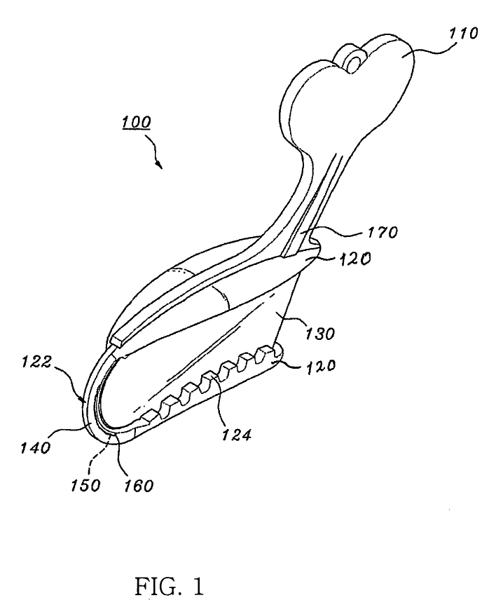

FIG. 1 is a plan view of the invented dental impression bite tray.

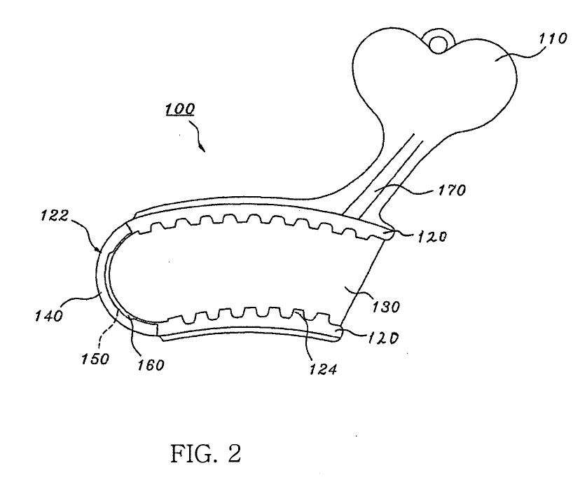

FIG. 2 is a side view of the invented dental impression bite tray.

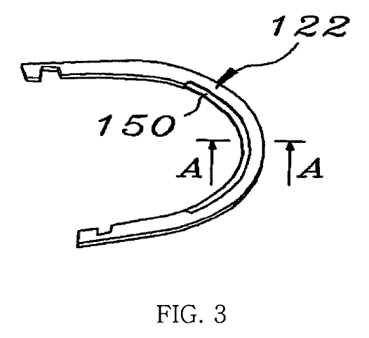

FIG. 3 is a side view of the fixed metallic reinforcement, which is inserted to the central portion of the impression mold of the invented dental impression bite tray.

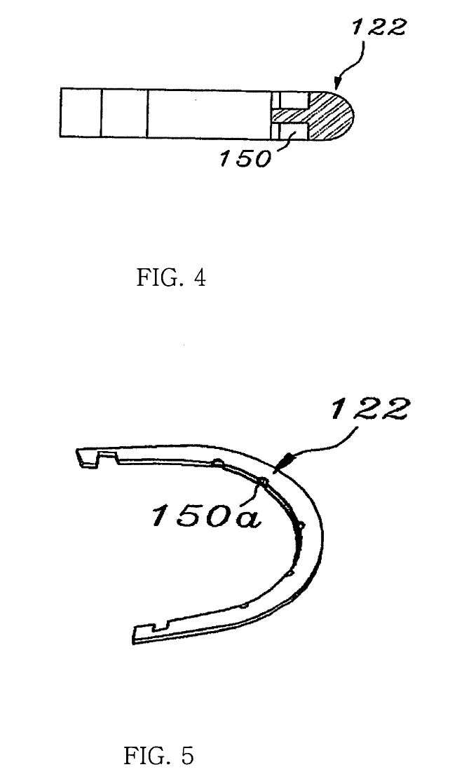

FIG. 4 is a cross-section view of A-A line shown in FIG. 3.

FIG. 5 is another side view of the metallic reinforcement.

The present invention, dental impression bite tray (100) is embodied in the apparatus shown in FIG. 1 or FIG. 3. The embodiments are as follows: a handle (110) for a patient and the left and the right side of the impression obtaining wall (120), which supports a side of the impression materials and locates beside of the handle (110); an impression membrane (130) in the central portion of the impression obtaining wall (120), to provide a hollow space for retaining impression materials; a supporter (170) to strengthen the handle (110); a central portion (140) that is linked to the left and the right side of the impression obtaining wall (120) in a hook shape; reinforcements (122) equipped on the inner and outer surface; and a moving freely prevention stair (150) that prevents interior moving freely of the reinforcement (122), which connect and unify the central portion (140) and the impression membrane (130).

The handle (110) and the impression obtaining wall (120) are made up of plastics. The materials used for the handle (110) and the impression obtaining wall (120) of the dental impression bite tray (100) are undoubtedly harmless. The material was selected from plastics, brasses, aluminiums, aluminium alloys, stainless steels, brass alloys, zinc alloys, general metals, and die casting molding elements. These materials are absolutely harmless and maintain the firmness of the handle (110) and the impression obtaining wall (120).

The thickness of the impression membrane is suggested to be 0.003 0.006 in, so that it can hold the impression materials and make an easy acquisition. This thickness range complements the official technique which presents a thickness of less than 0.003 in. The 0.003 inch-impression membrane is too thin and easily torn to obtain the impression materials, therefore, the thickness of the membrane is improved to the range of 0.003^{˜}0.006 in, which is the optimum condition.

The nonwoven fabrics or mesh are recommended to make the impression membrane (130) because the impression membrane (130), made up of nonwoven fabrics or mesh, not only helps to maintain the shape of the impression obtaining wall (120), but also helps the impression materials separate easily from the impression obtaining wall (120) after obtaining the impression. The improved impression membrane (130) also diversifies the impression materials that are easy to separate from the impression obtaining wall (120).

The plastic impression obtaining wall (120) of the dental impression bite tray (100) include reinforcements (122) prepared on the interior and exterior of the central portion (140). The component for the reinforcements (122) is selected from the following lists of the harmless materials. The lists include brass, aluminiums, stainless steels, brass alloys, zinc alloys, general metals, and die casting moldings. These materials will help maintaining the original wall of tray and preventing it from distorting, to obtain the dental impression safely and easily.

The jagged shape moving freely prevention projection (124) for impression materials is formed perpendicularly on the inner surface of the impression obtaining wall (120). This formation of the moving freely prevention projection (124) may minimize the moving freely of the impression materials forcing out to the direction of the tray's length.

The moving freely prevention projection for impression materials in a f jagged shape may be produced in two ways. One is that both sides are slant to the interior with a certain angle in a diamond shape. Another is that which both sides are slant from the exterior to the interior in an inverse-diamond shape, wave shape, or a jagged shape.

The moving freely prevention projection for the prenominate to impression materials may also be formed to preserve the established angle with keeping the jagged or the semicircular shape.

In the impression obtaining wall, to prevent movement of the impression materials, the prevention projection is horizontally formed with a plurality of recesses with a predetermined depth or a plurality of apertures.

The plastic and impression membrane moving freely prevention stair (150) should be prepared on the inner surface of the reinforcement (122) occluding the impression wall (12) and the circular-central portion (140).

The moving freely prevention stair (150) is to prevent the moving freely of the plastic-supporting area (160), which supports the impression membrane (130). The moving freely prevention stair (150) can substitute to the moving freely prevention groove (150a), which is formed with grooves in a certain distance, not a continuous groove.

The present invention has now been described with desirable reference, however, the scope of the present invention should not only be limited to the structures described in this application, but also by structures described by the language of the claims and the equivalents of those structures.

### INDUSTRIAL APPLICABILITY

In the present invention, a metallic reinforcement is added to the connecting loop on the both sides of the impression walls of the plastic tray. The reinforcement, produced thinly and narrowly, was exposed to the exterior, and, the both ends of the reinforcements were fixed by inserting to the impression walls. The reinforcement was also inserted to the inside of the central portion on the impression membrane and fixed with the plastic supporter. This structure would keep the merits of the conventional-plastic disposable bite tray, which is that the impression membrane inside of the connecting loop does not move up and down, and, the moving freely prevention stair and the moving freely prevention grooves help obtaining the impression finely and elaborately. The use of these reinforcements make the connecting loop, which is the weakest part of the tray, strong and rigid, even if the disposable bite tray is made up of plastics. In addition, the present invention complements the weakness of the conventional-plastic disposable bite tray. The width of the invented tray is adjustable as a metallic tray, the impression walls can be crossed, and the strength and rigidness of the invention prevent the deformation of the impression materials. It is also possible to make various models, such as posterior, half-side, sideless, quadrant, using the reinforcement for the disposable bite ray, so that dentists can use the disposable bite tray that is suitable for them, and prepare a safe and elaborate impression obtaining.

1. A dental impression bite tray comprising:
a handle for being held by an impression obtainer;
an impression obtaining wall for laterally support an impression materials for obtaining an impression during the obtainment of the impression, the impression obtaining wall being provided on the one side of the handle;
an impression obtaining membrane for providing a hollow space to retain the impression materials, the impression obtaining membrane being provided in the impression obtaining wall;
a reinforcement for integrally connecting a central portion being linked to the impression obtaining wall and the impression obtaining membrane from each other, the reinforcement being located inside or outside of the central portion; and
a prevention projection for preventing the movement of the impression materials, the prevention projection being provided in the impression obtaining wall.

2. The dental impression bite tray as set forth in claim 1, the impression obtaining membrane has the thickness of 0.003˜0.006 (inch).

3. The dental impression bite tray as set forth in claim 1, the impression obtaining membrane is made of nonwoven fabric.

4. The dental impression bite tray as set forth in claim 1, the reinforcement is made of the materials selected from the group including brass, brass alloys, aluminum, aluminum alloys, stainless steels, zinc alloys, general metals, and die casting moldings.

5. The dental impression bite tray as set forth in claim 1, the reinforcement is provided with prevention stairs.

6. The dental impression bite tray as set forth in claim 1, the reinforcement is provided with prevention grooves.

7. The dental impression bite tray as set forth in claim 1, the central portion is loop shape.

8. The dental impression bite tray as set forth in claim 1, the prevention projection is a jagged shape.

9. The dental impression bite tray as set forth in claim 8, the jagged shape is perpendicularly formed on the inner surface of the impression obtaining wall.

10. The dental impression bite tray as set forth in claim 8, the jagged shape has both sides being inwardly or outwardly slantingly formed.

11. The dental impression bite tray as set forth in claim 8, the jagged shape is formed in a wave shape, a serrated shape or a semi-circular shape.

12. The dental impression bite tray as set forth in claim 11, the serrated shape and the semi-circular shape are formed with a predetermined distance.

13. The dental impression bite tray as set forth in claim 8, the prevention projection is horizontally formed with a plurality of recesses with a predetermined depth or a plurality of apertures.
